(19) United States
(12) Patent Application Publication
(10) Pub. No.: US 2004/0164112 A1
(43) Pub. Date: Aug. 26, 2004

(54) ATV/SUV outdoor carry-all

(76) Inventors: Mark McClain, Soddy Daisy, TN (US); Jason Ledford, Hixson, TN (US)

Correspondence Address: RALPH E. SAUCIER Sr., 1927 Pierce Way, Buford, GA, 30519, US

(21) Appl. No.: 10/369,237

(22) Filed: Feb. 20, 2003

(51) Int. Cl. B60R 7/00; B60R 9/00; B60R 11/00

(52) U.S. Cl. 224/401; 224/519; 224/525

(57) ABSTRACT

The uniqueness of this invention is how many different things you can use it to carry. The name “The Outdoor Carry-All” is derived from the fact that the product is an outdoor product and is versatile in what it can carry. It also takes less time to take items on and off then anything on the market today. Simply pull one pin and you're done. There are no wrenches or time-consuming effort to put items on or take them off. This does not mount to the rack of an ATV, so it doesn't dent or scratch the rack or ATV.

By mounting in a receiver, this product moves with the ATV acting like a shock absorber so whatever you are carrying doesn't shake or move as much as it would if it were mounted to the rack. One of the benefits of this product is that it allows you to carry a lot items on the outside of a SUV or ATV so the items do not damage the vehicle.

As will be explained in the following pages the Carry-All is easy to take on and off, of your vehicle, and is easy to take apart for travel or storage. Another benefit of this product is that the consumer who is hunting can carry their game (such as a deer out of the woods), since an ATV can go where most vehicles can't go.

Purpose—of this invention is to give ATV riders and SUV owners a place to put a multitude of things in a place other than on the ATV or in their SUV or even carrying them on a backpack. It can carry hard gun case or bow cases, fold up chairs, gas cans, backpacks, all tree stands, lockons, duck and turkey decoys, coolers of many different sizes, dog kennels, ground blinds, and fold up tents and all the accessories that a camper will need. This product will give the rider more room around him or her and the opportunity to carry more equipment with them without being cramped. This product is for any type of hunting or outdoor enthusiasts.

The purpose of the Outdoor Carry-All is to make it more convenient for the operator of the ATV to be able to carry items in the field, whether it's for hunting, camping or just for the entertainment of going traveling through the terrain. The carrier compartments are design so they are easily attached to the Carry-All and will not in any way interfere with the functioning of the ATV. It is also design with structural 1018 tubing and welded and tested according to the American Welding Society Testing Standards to ensure welds will not break in the field.

Function—of the Carry-All will be further describe and how it function and how the operator needs to do to operate it. The outdoor Carry-All has four (4) adjustable legs that can slide back and fourth to accommodate may different products sizes. The gun and bow rack located on top can hold different sized models. The outdoor Carry-All has features that will allow you to fasten many different items most anywhere. The frame that comes out of the receiver is precisely angled so that when backing up or pulling forward over obstacles, it will not drag, instead it will slide over what ever is in your way.

This product also has add-ons like rectangular slide box on the back to carry backpacks, coolers, or anything you can put in the available space since the rectangular compartment has slides to make it adaptable for various size components. As mentioned, the adjustable deck would let the operator carry a full sized cooler, a dog kennel for duck or bird hunters or anything else that is needed for the field trip.

### Operating the Outdoor Carry-All

Attaching the Main Unit of the Carry-All to the ATV

Attaching the unit is very basic and does not even require a wrench. It is attached with a angle pin and a snap pin. To assemble it to the ATV and you align the Carry-All FIG. 1 (item 100 & 101) to the ATV so that the hole in the Carry-All front unit is in line with the hole on the hook-up FIG. 4 (item 102) of the ATV. After the holes in the two have lined up you then place the pin (item 103) and insert it into the hole of the two items. After the pin FIG. 5 (item 103) has been completely inserted you take the snap holding pin (item 104) and insert it into the hole of the holding pin (item 103). FIG. 2 and FIG. 3 also help to demonstrate the assembly of the unit from different a perspective.

Attaching the Top Carriage Holder to the Main Unit

The main carriage holder FIG. 6 (item 105) is attached by lining up the pin (item 106) to the center hole of the main holder (item 100). Resting the carriage down you then lock it down with the provided bolt (item 107). You only need to lightly tighten the unit. After the carriage is in place you then rotate if desired or leave it straight and put in the locking ball plunger pin FIG. 6 (item 108). As shown on FIG. 9 and FIG. 10 the carriage can rotate for your convenience of unloading or loading the Carry-All. The carriage (item 105) can also be adjusted by moving the side rails (item 106) and then locking the carriage in place with the thumbscrews provided with the Carry-All.

Attaching the Accessory Rack to the Carry-All

The accessory rack FIG. 11 (item 107) is attached by holding it even with the parallel bars (item 108) even with the main body (item 100) lifting it over the bars and sliding the “U” section (item 109) of the rack over the parallel bars. At the same time you do this, the “C” clamp (item 110) is slid over the (2) holes of (item 100). The bolts having been removed on (item 100) are then inserted back into the (2) holes clamping the accessory rack in place.

The accessory rack can then be adjusted to suit whatever accessory is going to be put in place for carrying by sliding the side rails and back rail FIGS. 1, 2, and 11 (item 111) to the desired size required then tightening them in place with the thumbscrews provided. FIG. 12 shows how the adjusting rails can be pulled out therefore allowing them to be adjusted to any size as long as they are secured in place in the main body of the accessory rack (item 107).

Attaching the Accessories to the Carrying Rack and the Accessory Rack

All accessories that are put on either rack are put on with bungee cords. This is done in a couple of different ways. If the case or accessory is large enough attaching the cord to (item 112) may be sufficient to secure the item. If not you may need a bungee cord that is large enough to wrap around the case or accessory to secure it to the FIG. 14 (item 112) hooks. FIGS. 11 and 13 show the best representation of the bungee cord hooks.

To install the hunters chair or any other chair into the chair holder FIG. 13, and 15 (item 113) you must first loosen the thumbscrew FIG. 13 (item 114) and open up (item 113) to accept the chair. After the chair has been nestled in the bottom (2) (item 113) you push the top (item 113) down onto the chair securing it. You then tighten up on the thumbscrew (item 114).

### BRIEF DESCRIPTION OF THE DRAWINGS

FIG. 1 Shows the ATV and the Carry-All on a side view and the simplicity of attaching.

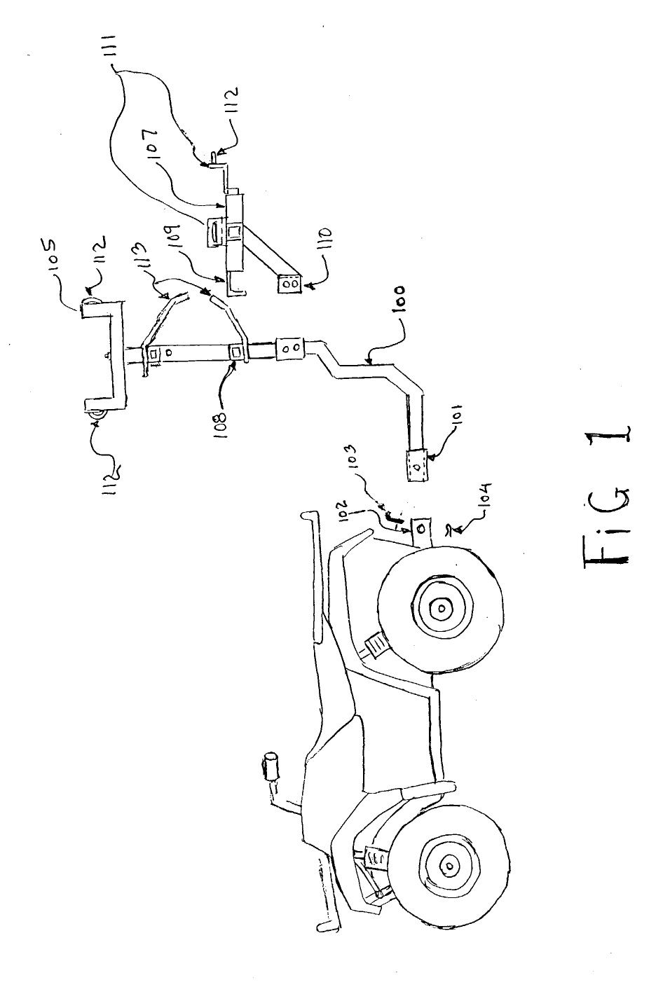

FIG. 2 Shows the ATV with the Carry-All and the box carrier from a top view and the alignment needed for all three.

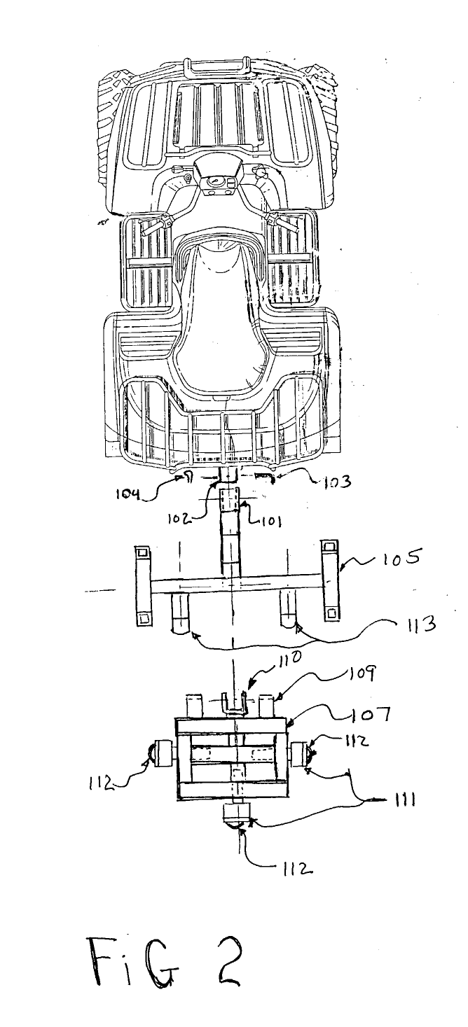

FIG. 3 Shows the back view of the Carry-All on the ATV and how convenient it is on the ATV.

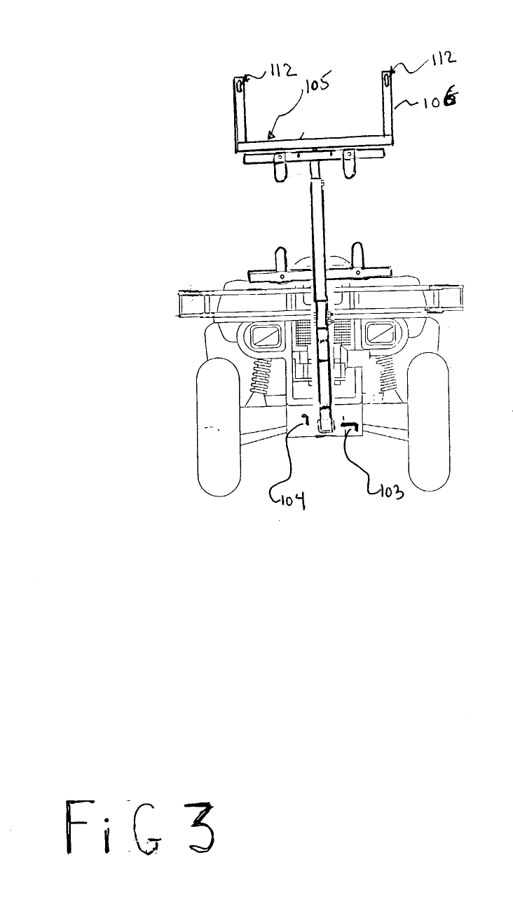

FIG. 4 Shows the easiness of attaching the Carry-All to the ATV.

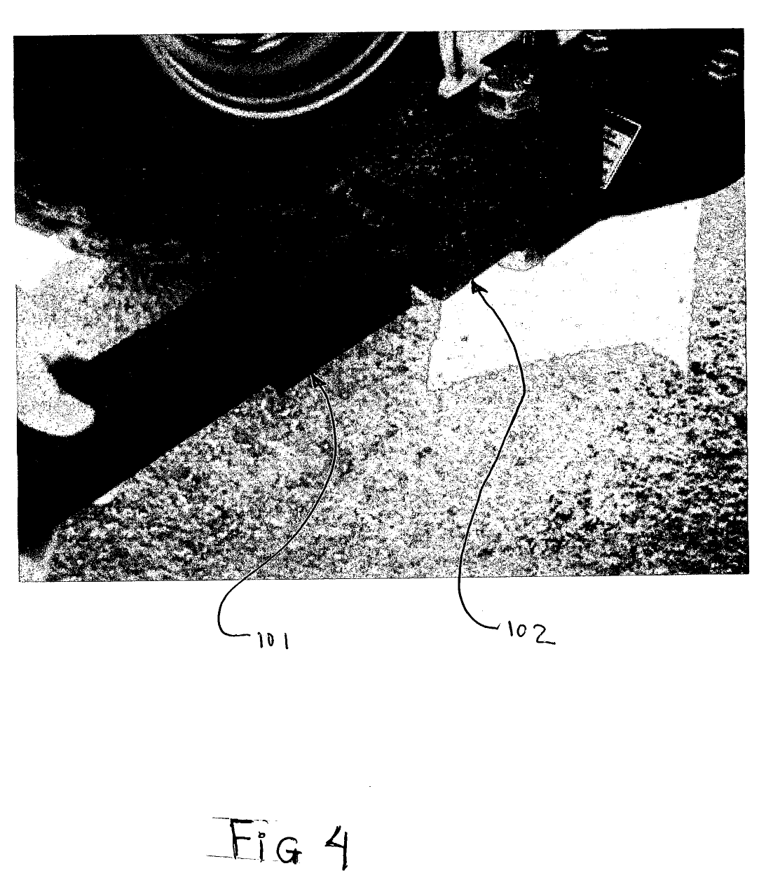

FIG. 5 Shows the simplicity of putting the pin in and then the snap holding pin in to complete the attachment.

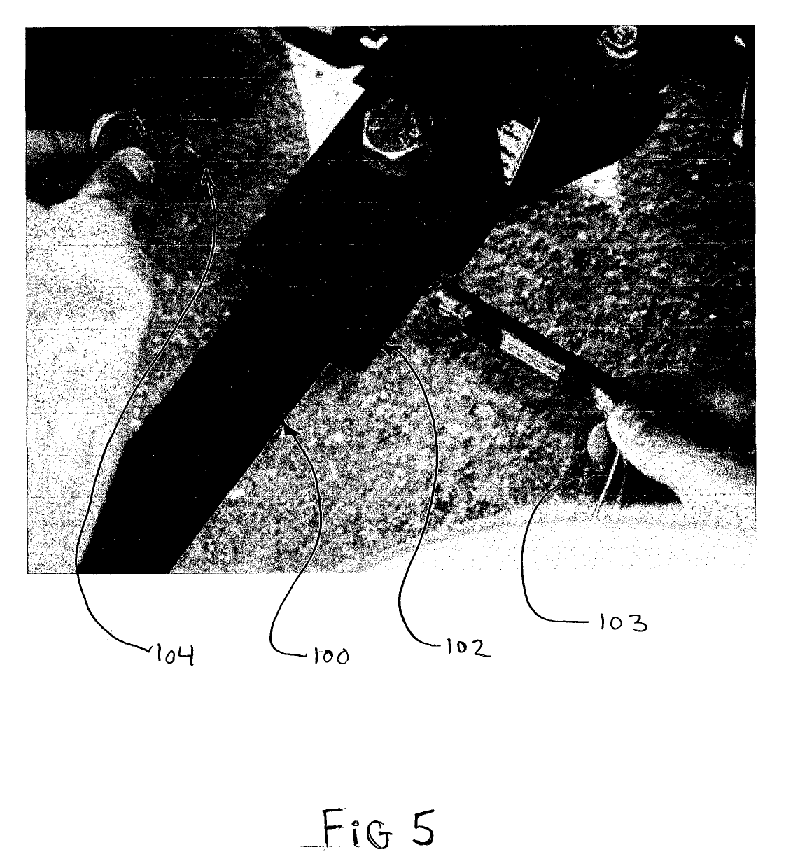

FIG. 6 Shows the screw for sliding the carriage over with the compass pin locator.

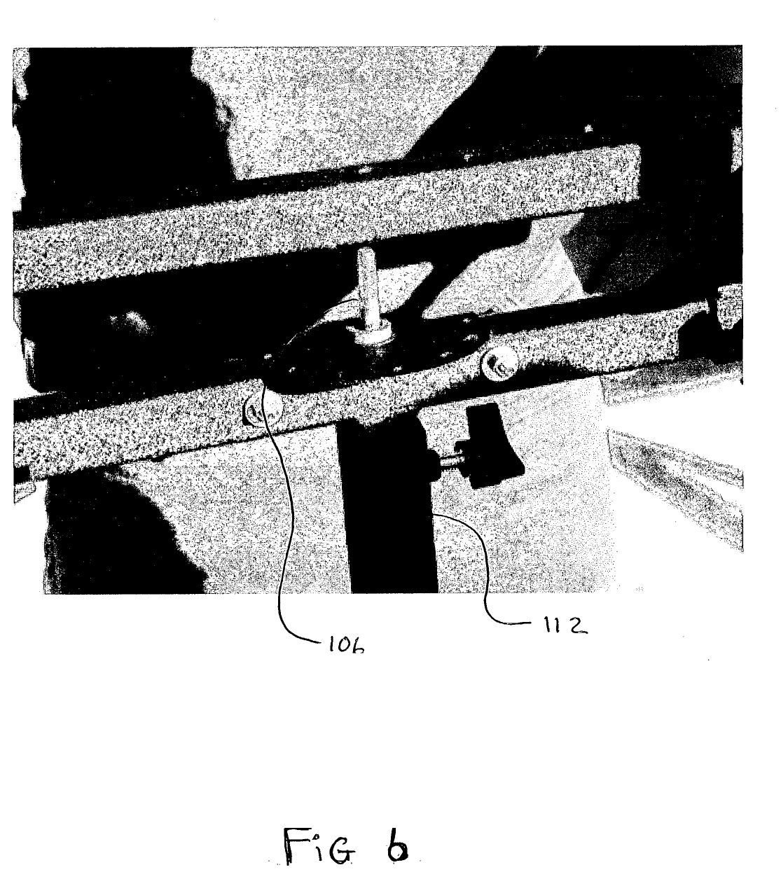

FIG. 7 Shows the nut in the locking position with the carriage in place.

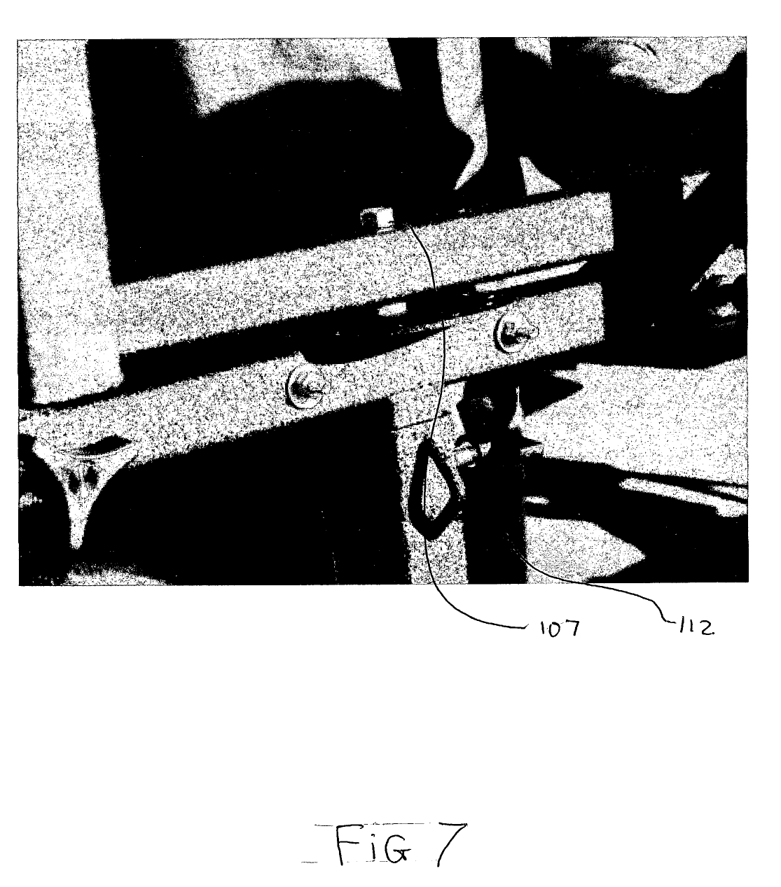

FIG. 8 Shows how you can rotate the carriage then lock it in place with the locating pin.

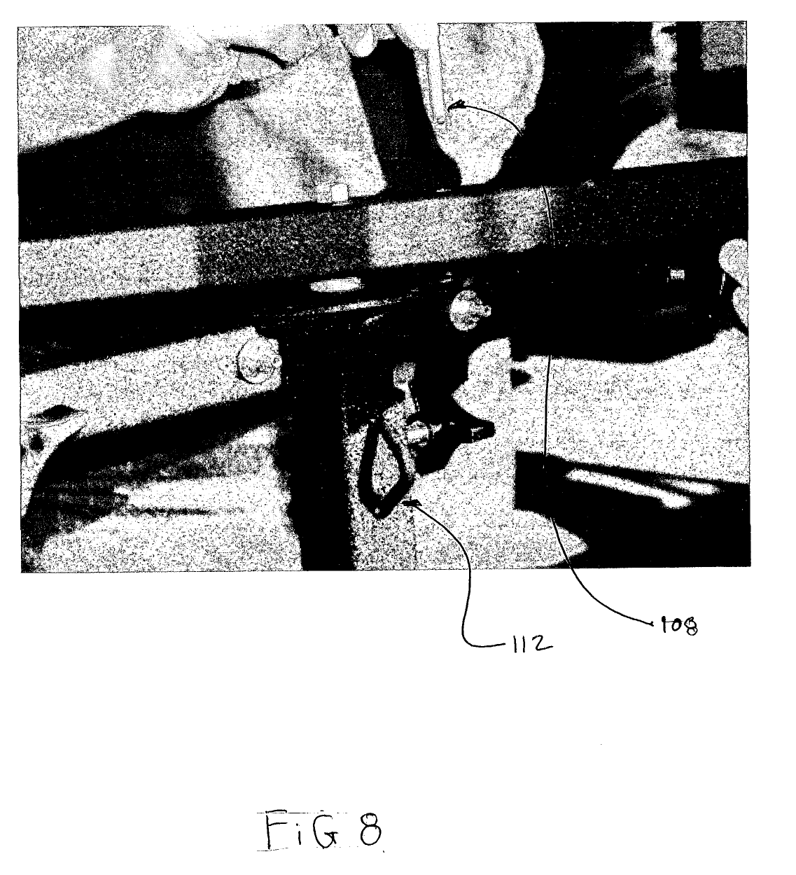

FIG. 9 Shows the hunting chair in position; attached to the back of the Carry-All.

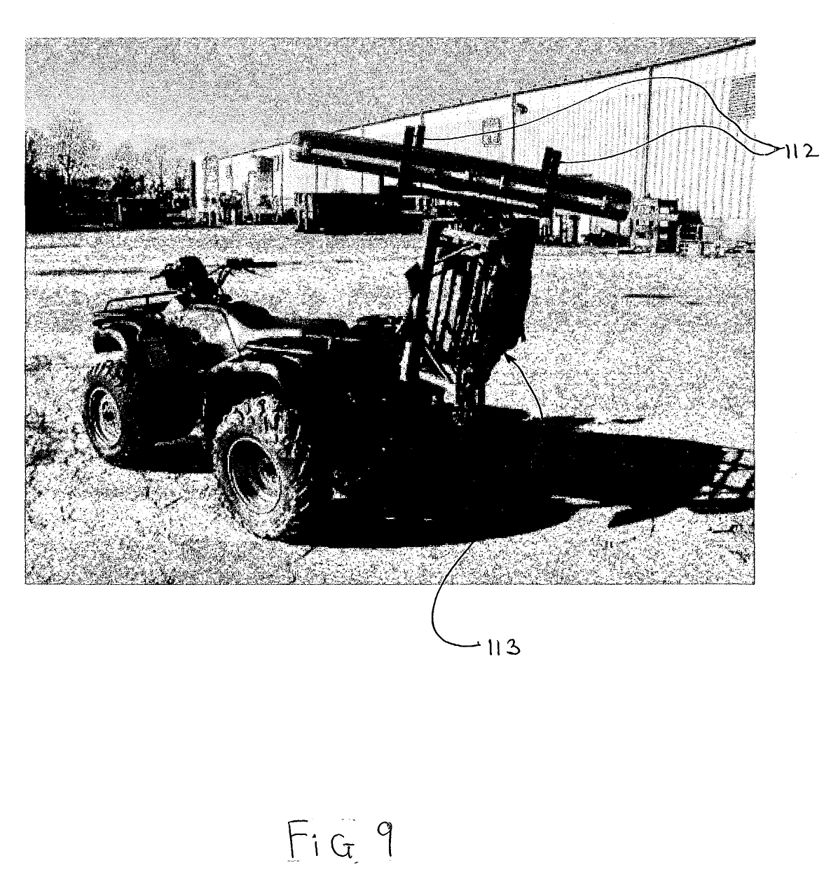

FIG. 10 Shows the carriage in the rotating position for the ease showing how easy it would be to unload and load it.

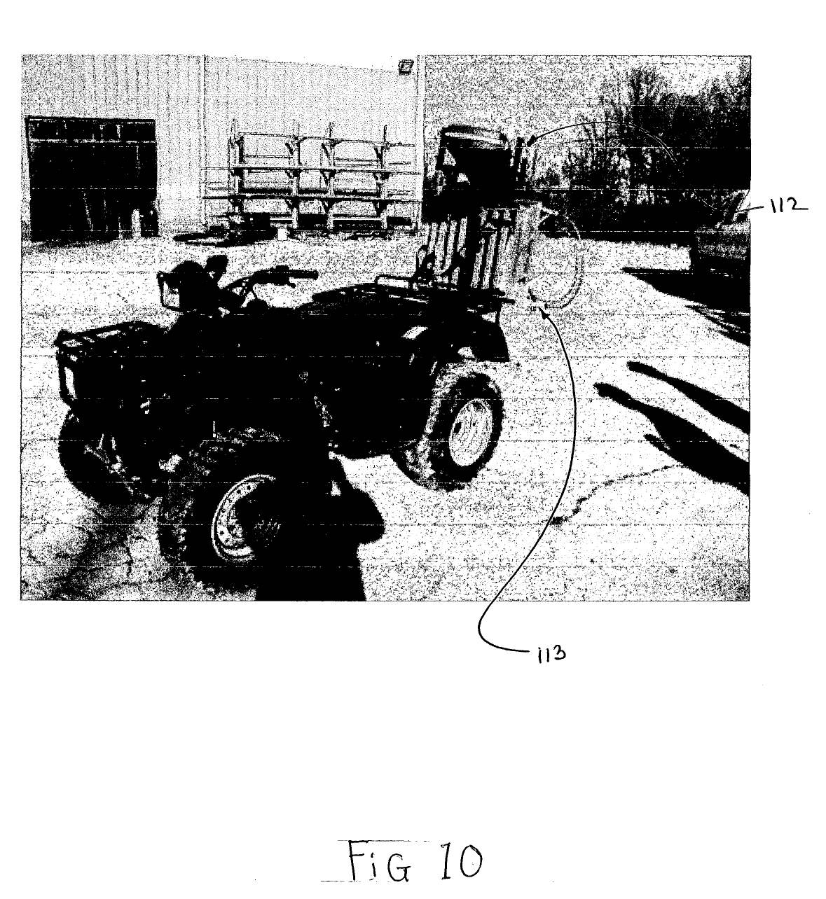

FIG. 11 Shows the box or cooler holder and how to hold it when installing it on the Carry-All.

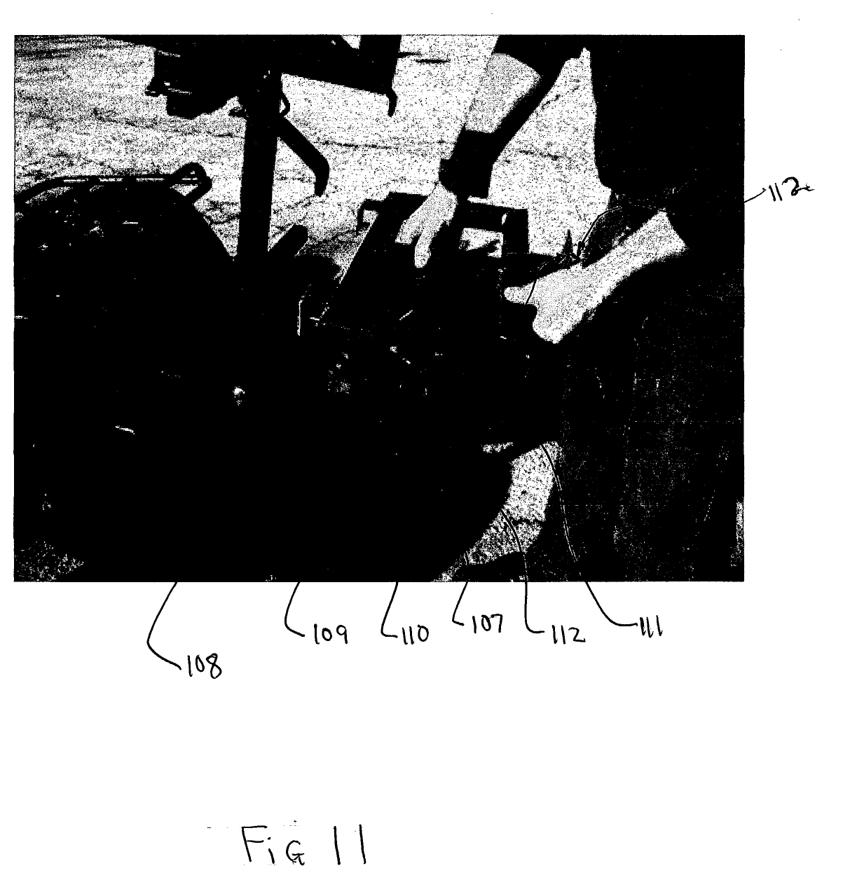

FIG. 12 Shows the box or cooler holder and the adjustable slide for adjusting the holder to different sizes.

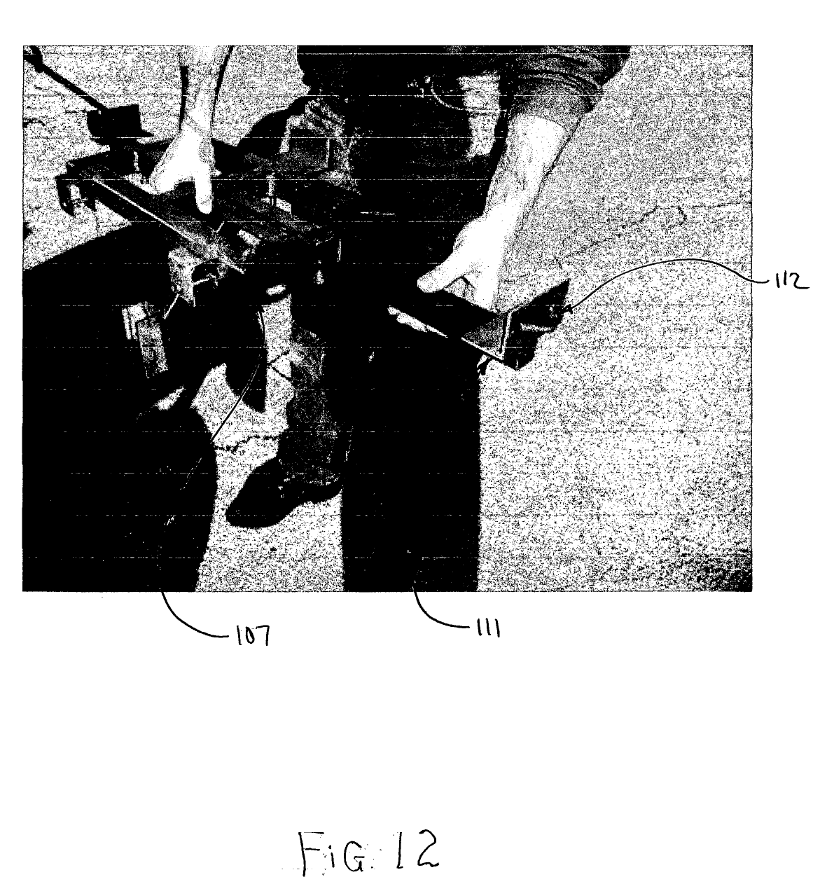

FIG. 13 Shows how a gun case would set on the carriage.

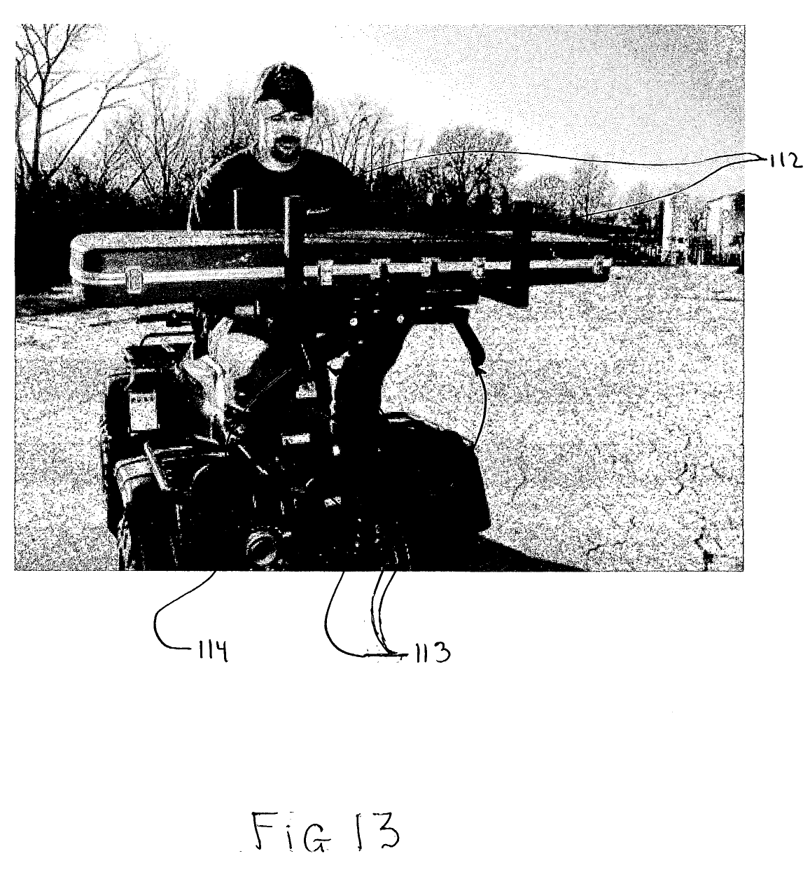

FIG. 14 Shows the ATV and the Carry-All and it does not obstruct the use of the ATV.

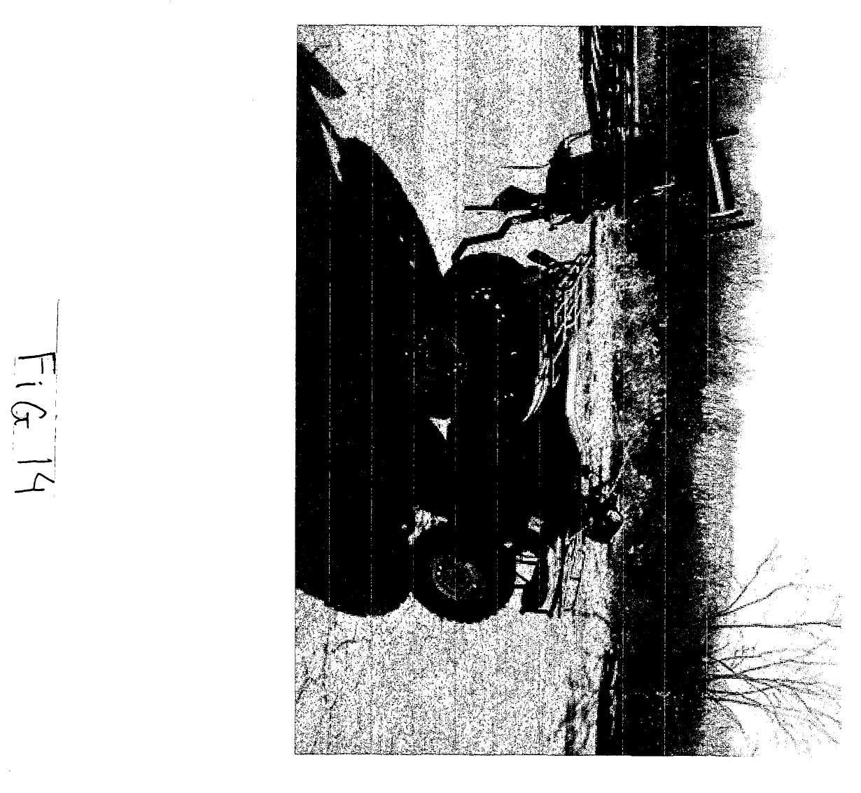

FIG. 15 Shows a side drawing of all the components of the Carry-All.

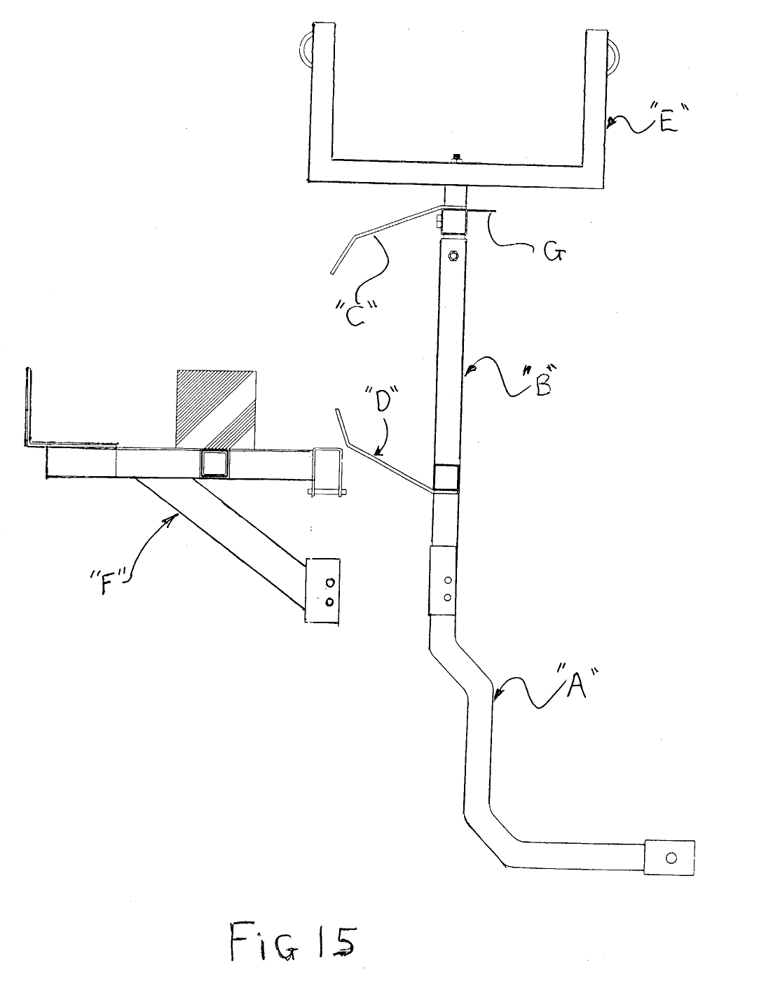

FIG. 16 Shows the adjustable compass for the carriage and how it will look after assembly.

### ASSEMBLY OF THE CARRY-ALL FROM THE SHIPPING BOX

The Carry-All comes package with “G” assembled to “B” and the rest of the components are packed in the box with an assembly instructions. The components to make up the Carry-All are listed below:

A. The lower arm assembly

B. The mid-upright assembly

C. The upper chair arm holder

D. The lower chair arm holder

E. The carriage holder

F. The basket holder

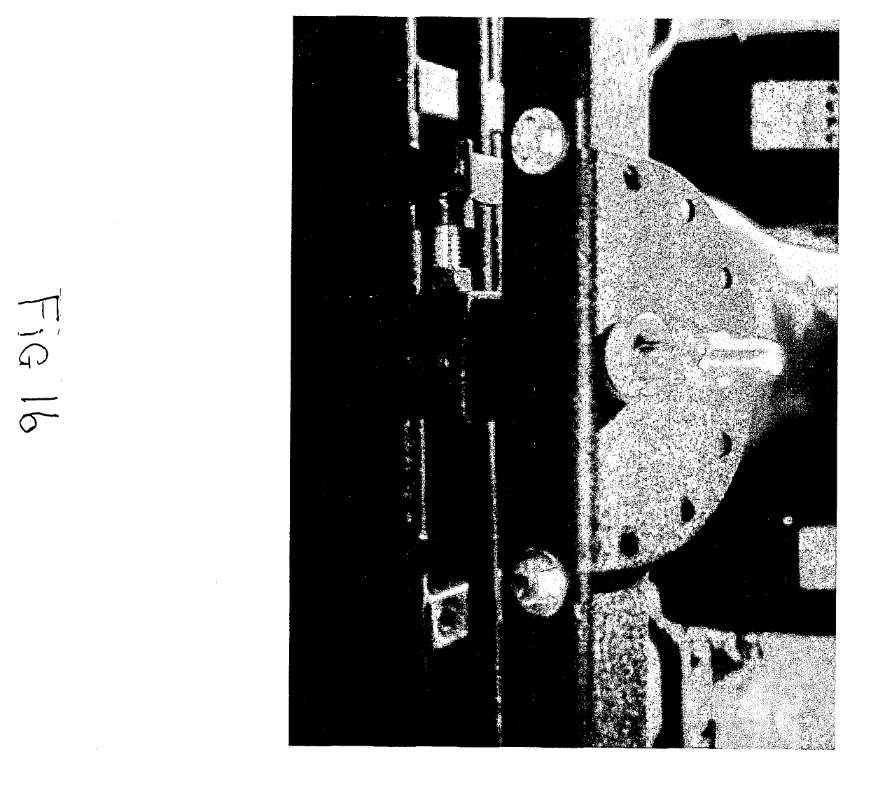

G. The traverse assembly, which would be attached to “B” in packaging. (FIG. 16) The assembly of the Carry-All can easily be done by:

a. First attaching “A” to the ATV.

b. Then attach “B” to “A” with the two screws provided.

c. Slide “C” and “D” into place and tighten them down.

d. “E” then can be placed on top of “B”.

e. “F” the basket holder can be attached as needed.

I claim:

1. A unique design claims to attach to all ATV and SUV vehicle to be attached and unattached to the vehicle with only one snap pin and anchor pin and will allow the owner to be able to carry cases or boxes being attached with bungee cords.

2. A box rack that is also expandable to be able to transport to any location for hunting or camping and which will allow the operator to carry cases or boxes.

3. Both the carriage and the box rack has a unique design of telescoping as to not to have to carry extra parts to make the adjustment. Both the carriage and the box rack are secured to the main frame in such a manner as not to allow them to rattle or come loose when being used in the terrain.

4. I claim it is designed and light enough as to allow the attachment to the vehicle to be done by one individual and is designed whereas the Carry-All does not interfere with the operation of the vehicle that is totally independent of the vehicle and still attached to the vehicle in such a manner to and does not hinder the function ability or the maneuverability of the ATV.6

5. A unique design that the Carry-All can be folded down and be carried in the trunk or in the back of a main vehicle as the ATV is being hauled in the back of another vehicle.

6. The unique design of having an adjustable rack to carry a lawn chair, a hunting chair or a table is not on any patent search or on the market today.

7. The patent application contains reference to a utility carriage and rack holder, which can be used on any ATV and SUV. Examples of such prior patents include: U.S. Pat. No. 6,016,943 to Johnson; U.S. Pat. No. 5,360,259 to Lemberger; U.S. Pat. No. 5,076,387 to Oka; U.S. Pat. No. 4,696,374 to Hale; U.S. Pat. No. 4,300,706 to Hendrick; U.S. Pat. No. 4,247,030 to Amacker; U.S. Pat. No. 4,277,008 to McCleary; and U.S. Pat. No. 4,176,771 to Dubroc. None of these make claim or cite the advantages referred to in this present invention.

8. The only Carry-All for ATV vehicles that is totally independent of the vehicle and still attached to the vehicle in such a manner to make it dependent on the vehicle and does not hinder the function ability or the maneuverability of the ATV.6
